(19) United States
(12) Patent Application Publication
(10) Pub. No.: US 2001/0040569 A1
(43) Pub. Date: Nov. 15, 2001

(54) System for driving a liquid crystal display with power saving and other improved features

(76) Inventor: Jemm Yue Liang, San Jose, CA (US)

Correspondence Address: SKJERVEN MORRILL MACPHERSON LLP, THREE EMBARCADERO CENTER, 28TH FLOOR, SAN FRANCISCO, CA, 94111, US

(21) Appl. No.: 09/766,498

(22) Filed: Jan. 19, 2001

Related U.S. Application Data
(63) Continuation-in-part of application No. 09/489,483, filed on Jan. 21, 2000.

(51) Int. Cl. G09G 5/00

(52) U.S. Cl. 345/212

(57) ABSTRACT

Power consumption for driving a liquid crystal display is reduced by connecting together row electrodes that are going through opposite voltage transitions so that the charges would cancel. After such charge cancellation, the respective row electrodes are then driven to respective target potentials by means of drivers. The row and/or column electrodes of the liquid crystal display may also be connected to storage capacitors so that the charges at these electrodes may be stored in the capacitors where the charges stored may be then reused subsequently to drive different electrodes towards target potentials, to reduce power consumption in the subsequent drive of the electrodes to their target potentials. The row voltage driving waveform is such that the driving voltage steps through two or more voltage increments before reaching a final value for turning on or off one or more pixels. This reduces shadows and improves quality of the display.

### CROSS REFERENCE TO RELATED APPLICATION

This is a continuation-in-part application of U.S. patent application Ser. No. 09/489,483, filed Jan. 21, 2000, which is incorporated herein in its entirety by reference for all purposes.

### BACKGROUND OF THE INVENTION

This invention relates in general to circuits for driving liquid crystal displays (LCDs), and in particular, to a system for driving liquid crystal displays requiring reduced amount of power for operating the display with other improved features.

LCD displays are used today for many different purposes, including laptop/notebook computers, handheld computers, cellular phones and personal digital assistants. These displays typically include a two-dimensional matrix of intersecting rows and columns of pixels, which are formed by the overlapping areas between an array of row electrodes intersecting an array of column electrodes arranged transverse to the row electrodes when viewed from a viewing direction by an observer. Images are displayed by the LCD displays by altering the optical transmission characteristics of a liquid crystal material layer disposed between the array of row electrodes and array of column electrodes. By applying suitable voltages between each row electrode and each column electrode, the portion of the liquid crystal layer at the pixel defined by the overlapping area between the intersecting row and column electrodes at such pixel would have a desired optical transmission characteristic so that all the pixels together would display a desired image.

In a simple driving scheme, the LCD display is driven by selecting or addressing one row of the display at a time, during which control voltages are also applied to each column electrode for altering or refreshing the image in such row. The period during which each such row is selected or addressed may be referred to as a “row drive period.” If there are 480 rows in the row array, according to this simple scheme, then there are typically 480 row drive periods for displaying the entire complete image of the LCD display in a complete display cycle. The full image of the LCD display is also referred to as a field. For convenience in description below, where a signal is used during a display cycle to display a portion of a field, the signal may be said to be displayed during such field; a row drive period of a display cycle to display a portion of a field may be said to be a row drive period during such field. After the completion of a display cycle during which each row of the row array has been selected or addressed for displaying a whole field, a new display cycle begins, and the process is repeated to refresh and/or update the displayed image.

The nature of liquid crystals is such that the application of a steady DC voltage to the liquid crystal will, over time, permanently change and degrade its physical properties. For this reason, it is common to apply voltages with alternating polarities to the pixels of the LCD display in a technique known as inversion.

An LCD display is typically addressed by means of an array of row electrodes, whose direction may be referred to as horizontal. In a general inversion scheme, the display screen may be divided into an arbitrary number of horizontal sections each addressed and covered by an arbitrary number of corresponding row electrodes. If the pixels in a first section of the display are driven with positive voltages, then the pixels in the adjacent section will be driven with negative voltages. During the next display cycle for the next field, the polarities are reversed. The same can be said for other sections of the display. In other words, for displaying the next field, the pixels in the rows of the first section are driven with negative voltages and the pixels in the rows of the adjacent section are driven with positive voltages during the next display cycle, and so on.

Where there is only a single section, the above general scheme is simplified and is known as a field inversion scheme. Where the sections are addressed by and cover the same number of row electrodes, the above general scheme is simplified and is known as a row inversion scheme.

Because of the above-described characteristics of liquid crystals, the polarities of the voltages applied to the row and column electrodes are constantly reversed, so that a significant amount of power is consumed in the driver circuits for driving these electrodes.

One of the most frequently heard complaints from users of portable computers, cellular phones and personal digital assistants is that these devices consume too much power so that one has to constantly change batteries, which is inconvenient. It is, therefore, desirable to provide a power saving system for driving LCD displays used in such devices.

In most LCDs, conductors are made of ITO traces, which generally has a resistance (“R”) of 10˜00 Ohm/square. Such high resistance traces can cause significant RC decay distortion on the scanning signals. For example, the traces leading from driver IC to the rows of pixels generally need to use very thin ITO traces to reduce ITO glass edge. There can be from 500˜5K squares and (5˜50K Ohm of resistance) along these traces.

In typical LCD design with modem material, each pixel has a capacitance (“C”) of 1˜5 pF. Furthermore, the pixel capacitance depends on the state of the pixel, where the capacitance is at it maximum at the ON state and at its minimum at the OFF state, where the capacitance during the ON state may be about 3˜4 times that in the OFF state. This difference in C will cause the RC delay to be different from row to row, and can create a shadow between two rows of pixels, where a large number of pixels on one of the rows is in the ON state, while the other rows have almost no ON pixels, such as frequently is the case in text display applications.

In COG (chip on glass) LCD manufacturing method, where the silicon die of IC is directly bounded to the ITO glass to save cost and size, there needs to be transition from the chip carrier ITO glass (generally the column electrode ITO glass plate) to other ITO glass (generally the row electrode ITO glass plate). These transitions are generally made of printed ACF (Asymmetrical Conducting Film) material. It is very difficult to control the uniformity of such material; non-uniformity of such material can cause large variation in the contact resistance from (row) electrode to (row) electrode. Such difference in R cause the RC decay to be different, and waveform to be distorted differently, and therefore cause a visible stripe pattern.

It is, therefore, desirable to provide a system for driving LCDs where the above-described undesirable effects on the display image are also reduced.

### SUMMARY OF THE INVENTION

In a typical driving scheme, the polarity of the row scanning signal is inverted every number of rows. Thus, in one simple driving scheme, the rows in the top half of the screen are scanned in one polarity whereas the rows in the bottom half of the screen are scanned in the opposite polarity. The scheme can obviously be modified by dividing the screen in other manners such as in thirds, fourths and so on, where the row electrodes in each fractional portion is scanned using signals of a polarity which is opposite to that used for scanning the adjacent fractional portions of the screen.

In a conventional row addressing scheme, the row electrode transitioning from a first voltage to a second target voltage will be driven by one driver and the another row electrode transitioning from the second voltage to the first target voltage will be driven by another driver. One aspect of the invention is based on the observation that, in any one of the above-described driving schemes, at some portion of the screen, there will be two rows undergoing opposite voltage transitions in reference to a reference potential. According to this aspect of the invention, by electrically connecting the two row electrodes undergoing opposite voltage transitions prior to connecting them to their respective drivers, power consumption of the LCD display will be reduced.

Thus, in an embodiment where the reference potential is at the halfway point between the first and second potentials, by connecting two row electrodes together that are undergoing opposite voltage transitions between the first and second voltages, both row electrodes will end up at the reference potential, so that their respective drivers will only need to drive the two row electrodes from the reference potential to their respective desired target potentials. Power consumption is, therefore, reduced compared to the conventional driving scheme.

In a LCD display, the overlapping portions of the intersecting electrodes form opposing plates of a capacitor, so that the intersecting portions of the two arrays of electrodes form a two-dimensional array of capacitors. The optical transmission properties of a pixel are therefore determined by the electrical potentials applied to the opposing capacitor plates of the intersecting row electrode and column electrode that define such pixel. By controlling electrical potentials applied to the opposing plates associated with the pixel, the optical transmission properties of the pixel are determined.

As noted above, because of the inherent properties of liquid crystals, the electrical potentials of the row and column electrodes are frequently caused to transition between at least a first and a second electrical potential. Another aspect of the invention is based on the observation that, in a passive LCD display, by connecting at least one electrode undergoing such transition to a storage capacitor at an electrical potential between the two potentials, at least a portion of the charge originally at the electrode will be transferred to the storage capacitor. By means of such transfer, the electrical potential of the electrode is also brought closer to the value of the target electrical potential it is transitioning to, so that the driver for driving the electrode will only need to drive it by a reduced potential difference, thereby reducing power consumption.

Power consumption can also be reduced in a passive LCD display by connecting one or more column electrodes undergoing voltage transitions to a common node to reduce power consumption. Thus, in one embodiment, if a number of column electrodes are undergoing voltage transitions, by connecting all of these electrodes to the row electrodes that are not being scanned or addressed, this causes the column electrodes undergoing voltage transitions and the row electrodes that are not being scanned to be electrically connected. This causes the charges on the opposite plates of the capacitors formed by these column and row electrodes to be discharged. The column electrodes will then be at substantially the non-scanning potential of the row electrodes. Power consumption will be reduced in subsequently driving these electrodes to their target potentials.

As noted above, the different capacitance values for pixels in the On and OFF states and non-uniformity of the ITO traces cause differences in the RC delays in the driving signals applied to the row electrodes and can cause undesirable effects on the displayed image. Furthermore, it is noted that the change in optical properties in the liquid crystal layer in a LCD device responds to the root mean square value of the voltage applied across the layer, so that the optical properties of the layer are the most sensitive to the peak of the driving voltage waveform. According to the invention, where the value of the voltage across one or more portions of the liquid crystal layer for causing such portions to change optical properties is reached in two or more increments, the above described undesirable effects will be reduced, thereby also improving the quality of the image displayed by the LCD.

### BRIEF DESCRIPTION OF THE DRAWINGS

FIG. 1 is a schematic front view of an LCD panel and its row and column electrodes useful for illustrating the invention.

FIG. 2 is a graphical illustration of voltages applied to row and column electrodes of FIG. 1 useful for illustrating the invention.

FIG. 3 is a schematic circuit diagram of three representative circuits forming a portion of a control circuit for driving the row electrodes of FIG. 1 to illustrate the preferred embodiment of the invention.

FIG. 4 is a table illustrating the operation of the circuits of FIG. 3.

FIG. 5 is a graphical illustration of the voltage transitions of the row electrodes in accordance with the table of FIG. 4.

FIG. 6 is a graphical illustration of three representative circuits forming a portion of a control circuit for driving the row electrodes of FIG. 1 in an alternative embodiment of the invention.

FIG. 7 is a graphical plot of the waveform for voltages of row electrodes achieved using the circuits of FIG. 6.

FIG. 8 is a schematic circuit diagram of three representative circuits forming a portion of a control circuit for driving the column electrodes of FIG. 1 to illustrate another embodiment of the invention.

FIG. 9 is a table for illustrating the operation of the circuits of FIG. 8.

FIG. 10 is a graphical plot of the waveform of the voltage transitions of the column electrodes to illustrate the operation of the circuits of FIG. 8.

FIG. 11 is a graphical illustration of voltages applied to row electrodes of FIG. 1 useful for illustrating a row inversion scheme.

FIG. 12A is a graphical plot of the voltage differences between a selected row and a selected column electrode for an ON and for an OFF pixel to illustrate a conventional scheme for addressing LCD displays.

FIG. 12B is a graphical illustration of the voltage differences between a selected row and a selected column electrode for an ON and for an OFF pixel where the voltages applied are caused to step in two increments to illustrate an embodiment of the invention.

FIG. 13A is the graphical plot of FIG. 12A where the graphical representations of the voltage differences are approximated by two lines useful to illustrate the advantages of the invention in the embodiment of FIG. 12B.

FIG. 13B is a graphical plot of FIG. 12B and lines that are approximations of the voltage differences shown therein to illustrate the advantages of the invention in the embodiment of FIG. 12B.

FIG. 14 is a block diagram of a portion of a voltage supply and an LCD to illustrate an embodiment of the invention.

For simplicity in description, identical components of this application are identified by the same numerals.

### DETAILED DESCRIPTION OF THE PREFERRED EMBODIMENTS

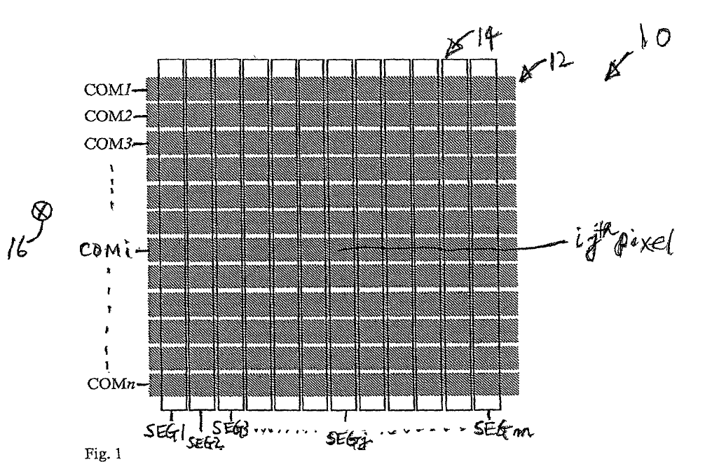

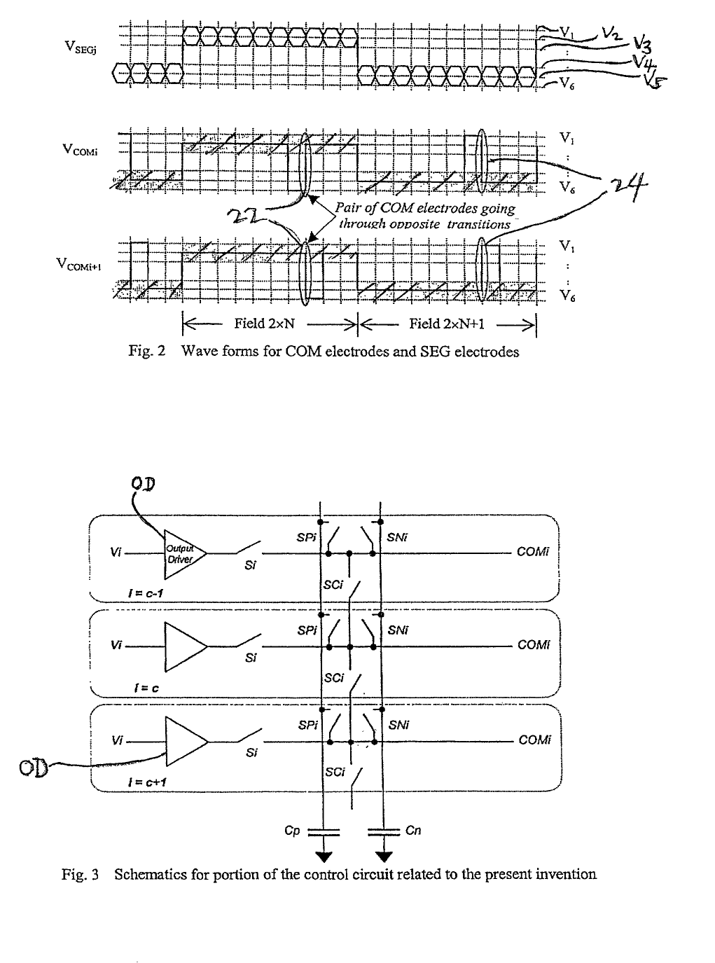

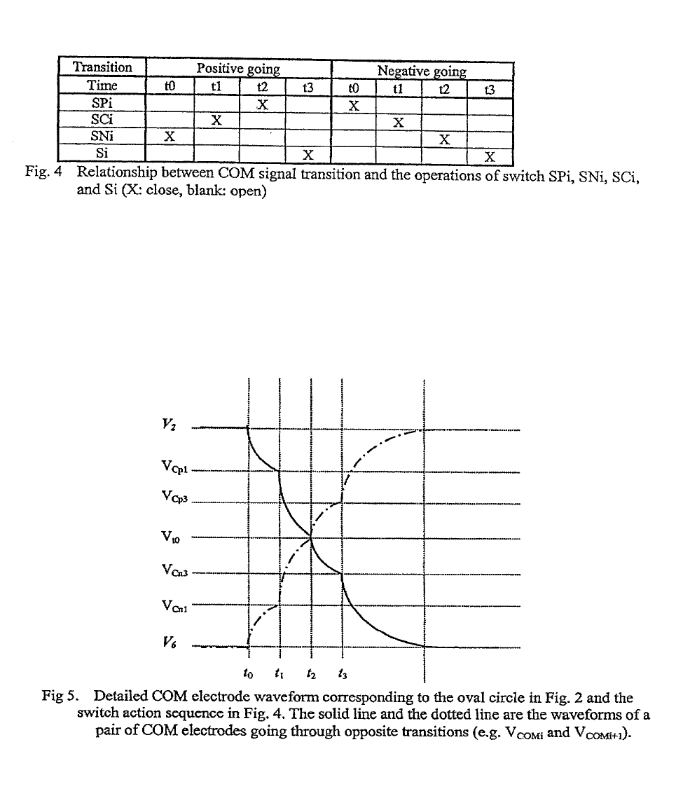

Referring to FIGS. 1 and 2, a typical configuration of passive LCD and its driving waveform is illustrated. As demonstrated in the LCD panel 10 of FIG. 1, panel 10 includes an array 12 of n elongated row electrodes and their respective nodes COM1, COM2, COM3, . . . , COMn where the ith (i=1, 2, . . . n) row electrode is connected to the node COMi at voltage V_{COMi}, and an array 14 of m elongated column electrodes and their respective nodes SEG1, SEG2, . . . SEGm where the jth (j=1, 2, . . . , m) column electrode is connected to the node SEGj at voltage V_{SEGj}, where n, m are positive integers. The two arrays of electrodes are arranged transverse to one another so that each row electrode intersects and overlaps each column electrode at an overlapping area, where the overlapping area when viewed in a viewing direction by a viewer (such as the direction 16 perpendicular and into the plane of the paper in FIG. 1) defines a pixel, such as pixel ij or ijth pixel at the ith row and jth column at the intersection of the ith row and jth column electrodes as shown in FIG. 1.

The overlapping portions of the ith row and jth column electrodes form an opposing pair of capacitor plates with a layer of liquid crystal material (not shown) in between which is substantially co-extensive with the arrays 12, 14 in panel 10. By applying the appropriate electrical potentials or voltages to the ith row and jth column electrodes through their respective nodes, COMi, SEGj, the opposing capacitor plates at the ijth pixel are set to desired electrical potentials so that the layer of liquid crystal material between the plates experiences a certain electric field, causing the optical transmission of the ijth pixel to be of a desired value.

FIG. 2 is a graphical illustration of voltages applied to row and column electrodes of FIG. 1 in a field inversion scheme useful for illustrating the invention, where two complete display cycles for displaying the 2xN and 2xN+1 fields are shown. To simplify the description, the simplified waveforms of FIG. 2 are suitable for driving a LCD display with 10 rows, where only one row is addressed or scanned at one time, so that each display cycle has 10 row drive periods, each for driving a corresponding row electrode. In FIG. 2, where vertical axis represents voltage, and the horizontal axis time, the data signals V_{SEGj} are “0s” and “1s” and are also drawn as the overlapped shaded region over the V_{COMi} signals to illustrate relative relationships between these two sets of signals. For convenience, row and column electrodes are also referred to below as COM and SEG electrodes respectively, and the selection (addressing) and data signals applied thereto the COM and SEG signals or pulses respectively.

In FIG. 2, when the ith row electrode is scanned in the 7th row drive period during field 2xN, node COMi is at V₆, and the remaining row electrodes are at V₂. In the remaining 9 row drive periods when the ith row is not addressed or scanned during the cycle for field 2xN, node COMi is also at the potential V₂. Similarly, when the (i+1)th row electrode is scanned in the 8th row drive period during cycle for field 2xN, node COMi+1 is at V₆, and the remaining row electrodes are at V₂. In the remaining 9 row drive periods when the (i+1)th row is not addressed or scanned during cycle for field 2xN, node COMi+1 is also at the potential V₂. Thus during cycle for field 2xN, the scanning potential or voltage is V₆ and the non-scanning potential or voltage is V₂. During cycle for field 2xN+1, when the ith row electrode is scanned in the 7th row drive period, node COMi is at V₁, and the remaining row electrodes are at V₅. In the remaining 9 row drive periods when the ith row is not addressed or scanned during cycle for field 2xN+1, node COMi is also at the potential V₅. Thus during cycle for field 2xN+1, the scanning potential or voltage is V₁ and the non-scanning potential or voltage is V₅. As shown in FIG. 2, the scanning and non-scanning potentials of the ith and (i+1)th row electrodes are the same, but the scanning potential is applied to the (i+1)th row electrode one row drive period later than that applied to the ith row electrode. From the above, it is seen that the non-scanning potential for the row or COM electrodes alternates between V₂ and V₅, and may be accomplished by using a switch to alternately connect node COMi to voltage sources at V₂ and V₅, in the manner shown in FIG. 8 described below.

During the display cycle for field 2xN, the potentials of the column electrodes may be at V₁ or V₃, and during cycle for field 2xN+1, the potentials of the column electrodes may be at V₄ or V₆, depending on the value of the data applied to such column electrodes. In other words, the potentials of the column electrodes “float” about the non-scanning potentials for the row electrodes during the display cycle for such field. Thus during the cycle for field 2xN where data signal V_{SEGj} is “0”, this means that the jth column electrode is at V₃, so that the potential difference V₃-V₆ is inadequate to turn on the pixel. But where data signal V_{SEGj} is “1”, this means that the jth column electrode is at V₁, so that the potential difference V₁-V₆ between the ith row electrode and the jth column electrode is adequate to turn on the pixel. During the cycle for field 2xN+1 where data signal V_{SEGj} is “0”, this means that the jth column electrode is at V₄, so that the potential difference V₁-V₄ is inadequate to turn on the pixel. But where data signal V_{SEGj} is “1”, this means that the jth column electrode is at V₆, so that the potential difference V₁-V₆ is adequate to turn on the pixel. The SEG and COM signals combine with each other to produce pixel charges of opposite polarity between even fields and odd fields. In other words, the optical transmissive characteristics of the corresponding pixel change in response to the absolute (root mean square) value of the potential differences between the corresponding overlapping COM and SEG electrodes.

From the waveform of these signals, it is observed that during the successive row selection COM pulses, significant voltage difference between the row or COM electrode being scanned and the column electrodes SEG1˜SEGk carrying data is developed. Due to the capacitive loading characteristics of LCD pixel cells (i.e. capacitance between the opposing capacitor plates of the pixel), these voltage swings will require significant charges to be pumped into or out of the addressed row of pixels. The straight forward and conventional implementation is to connect output drivers directly to the COM electrodes of LCD and, therefore, will consume significant power in the output during these charge transferring operations.

Referring to FIG. 2, it will be observed that for each row selection process, there is always a pair of COM electrodes going through opposite transitions, such as indicated by the pairs of ellipses 22, 24 in FIG. 2, with substantially the same magnitude V₂-V₆ or V₁-V₅ of voltage swing, but in the reverse or opposite directions relative to the shaded SEG signals. As will also be observed in FIG. 2, even though the i^{th} and the (i+1)^{th} rows are scanned by signals of the same polarity, it will be understood that in any row inversion scheme, at least two rows (although they may not be adjacent to each other) will be found where their addressing signals are undergoing opposite voltage transitions substantially simultaneously. Such and other variations are within the scope of the invention.

This invention introduces a new driving scheme to take advantage of these pairing of transitions which utilizes a new circuit configuration for the output stage and a charge conserving operating procedure that can save up to ¾ or more of the charges required to complete the necessary COM electrode swings.

Circuit Schematics and Operation

FIG. 3 is a schematic circuit diagram of circuits for driving the row electrodes of FIG. 1 to illustrate the preferred embodiment of the invention. In FIG. 3, c is any integer greater than 1 and less than n. Referring to the schematic in FIG. 3, the switch action table in FIG. 4 applies to a pair of row electrodes (e.g. the ith and (i+1)th row electrodes in FIG. 2). As shown in FIG. 4, an “X: in the table indicates that the corresponding switch in the left column is closed at the time indicated in the top row, and a blank indicates that the corresponding switch in the left column is open at the time indicated in the top row. For example, for the positive going transition, the switch SNi is closed at time t0, but open at other times (t1, t2, t3). The expected voltage waveform of the pair is shown in FIG. 5. Instead of connecting COMi electrode driving signal (Vi) directly from the output driver OD (symbolized as a triangle in the schematics) to the ith COM electrode (COMi), this invention introduces three additional phases of operation via the introduction of four switches: Si, SPi, SNi, and SCi. FIG. 5 illustrates the voltage transitions for a pair of COM electrodes going through opposite transitions such as the one illustrated in FIG. 2 and highlighted by the ellipses 22, 24 in FIG. 2.

As demonstrated by the example shown in FIG. 5, the operation of the presently proposed driving scheme introduces three additional phases:

t0˜t1: Storage phase: Charges are stored into proper storage capacitor. In the case shown for field 2xN in FIG. 2, in ellipses 22, the ith row electrode transitions from V₆ to V₂, and the (i+1)th row electrode transitions from V₂ to V₆. Thus the ith row electrode is connected to capacitor Cn at time t0, and transfers a portion of its negative charge to Cn, so that at time t1, it is at potential V_{cn1}. The (i+1)th row electrode is connected to capacitor Cp at time t0, and transfers a portion of its positive charge to Cp, so that at time t1, it is at potential V_{cp1}.

t₁˜t₂: Reset phase: The pair of opposite going COM electrodes are connected together to neutralize the remaining opposite charges of each other so that at time t2, they are at potential Vₜ₀.

t2˜t3: Transfer phase: The charges of the storage capacitors are transferred to the appropriate COM electrodes. Thus for ellipses 22 in FIG. 2, the positive charges of capacitor Cp are transferred to the ith row electrode to cause its potential to be V_{Cp3}, and the negative charges of capacitor Cn are transferred to the (i+1)th row electrode to cause its potential to be V_{Cn3}.

t3˜: Drive phase: Driving voltage is applied by connecting the drivers OD to the respective COM electrodes (like conventional scheme) to drive the potential of the ith row electrode to V₂ and the potential of the (i+1)th row electrode to V₆. Only a portion of this phase is illustrated in FIG. 5. The same phases apply to ellipses 24 for the field 2xN+1.

The operation of each switch is as demonstrated in FIG. 4. As shown by the example illustrated in FIG. 5, with the present scheme, the output drivers OD will only need to supply charges to the COM electrodes for the transition from V_{Cn3} to V₆ for the negative going COM electrode and from V_{Cp3} to V₂ for the positive going COM electrode.

When the capacitances of storage capacitors (Cp and Cn) are increased relative to the capacitive loading (C_{L}) as seen from each COM electrode, the gap from V_{Cn1} to V_{Cn3} and from V_{Cp1} to V_{Cp3} will be gradually reduced. Assuming Cp, Cn>>C_{L}, then it is expected V_{Cp1}≈V_{Cp3}, V _{Cn1}≈V_{Cn3}, and |V_{Cp3}−V₂|≈|V_{Cn3}−V₆|≈¼|V₂-V₆|. Under such circumstance, a reduction of approximate 75% of the charges flowing through output drivers to COM electrodes is possible, as compared to conventional direct drive mechanism.

The statement “a pair of COM electrodes going through opposite transition” can refer to any pair of adjacent COM electrodes, i.e. COMᵢ and COM₁₊₁ in FIG. 2, or between the first electrode COM₁ and the last electrode COMₙ, or any other sequence of COM scanning order.

Alternative Embodiment

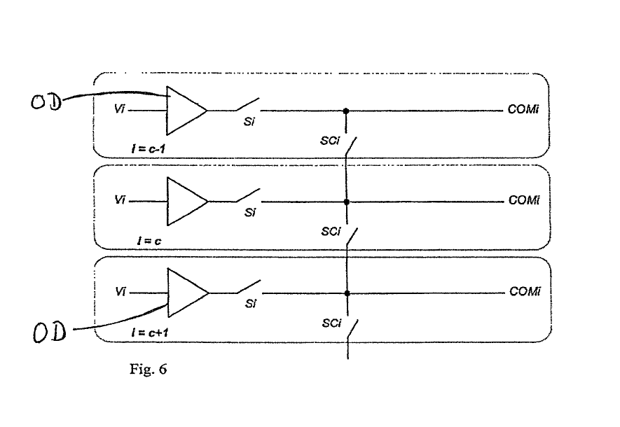

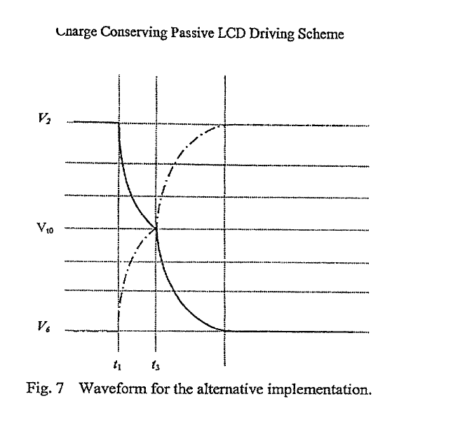

Another simplified version of the present invention is illustrated in FIG. 6 and FIG. 7. This modified driving scheme is to utilize only the switches Si, SCi and do without storage capacitors Cp, Cn and their associated switches SPi and SNi. The switch table of FIG. 4 is simplified by eliminating the entries for t0 and t2 and the associated waveform for the COM electrode is illustrated in FIG. 7.

As illustrated in the COM waveforms in FIG. 7, under this simplified scheme, due to the charge cancellation effect of the reset stage (time t1 to t3), the output driver will only need to supply current for the second half of the transitions (after time t3). Therefore when compared to conventional schemes where output drivers are connected directly to the COM electrodes to drive them from V₂ to V₆, or from V₆ to V₂, this approach has the potential of saving 50% of charges required to be pumped into/out of the COM electrodes by the output drivers. However, due to the lack of the storage capacitors Cp and Cn and the associated charge storage and transfer process, this simplified configuration cannot generate the higher 75% of power saving which is possible under the more elaborated scheme. Since the two row electrodes undergoing opposite voltage transitions between V₂ and V₆ have substantially the same amplitude, it is possible to connect them and cancel their charges so that they are at the common mid-point voltage value between V₂ and V₆.

Other embodiments

It is also possible to omit the phase where the row electrodes are connected to cancel their charges, such as by omitting the entry under time t₁ in FIG. 4. It is also possible to employ a single capacitor or more than two capacitors rather than two capacitors Cp, Cn, with or without charge cancellation by connecting the pair of row electrodes. By using more than two capacitors, it is possible to reduce power consumption by more than 75%, at the expense of using more capacitors and more switches. Since power is also required for operating the additional switches, there may be a point of diminishing returns when more capacitors and switches are used. Such and other variations are within the scope of the invention.

Column Electrodes

Referring again to FIG. 2, the data signals, the data signals V_{SEGj} are “0s” and “1s” and are also drawn as the overlapped shaded region over the V_{COMi} signals to illustrate relative relationships between these two sets of signals. From the waveform of these signals it is observed that during the successive row selection COM pulses, and between different fields of V_{SEGj} signal, the COM and SEG electrodes experience significant voltage sweeps as a result of charges pumped into or out of the addressed row of pixels. The conventional implementation is to connect output drivers directly to the COM and SEG electrodes of the LCD panel 10 and, therefore, will consume significant power in the output drivers during these charge transferring operations.

In the conventional driving scheme, SEG electrodes are connected directly to one of the proper driving voltages, such as V₁ or V₃ during even fields (field 2xN and V₄ or V₆ during odd fields (2xN+1). Under such driving scheme, all transitions between these voltages will be consequences of these direct charging or discharging operations through one of the voltage sources, and therefore consume power.

V_{COM} is the non-scanning voltage applied to the COM electrodes (i.e. V₂ in FIG. 2 during the even fields and V₅ during the odd fields) that are not selected or addressed. It is observed that, from the perspectives of SEG electrodes, the value V_{SEG}-V_{COM} may be mathematically represented by the following formula which uses the convention of the C programming language:

(Dti⊕Fti)⊕(Dti−1⊕Fti−1)×((Dti⊕Fti)?+1:−1)×2×Vd (1)

where

⊕ is logic operation XOR

Dti is the data driving a certain SEG electrode SEGk in row drive period i

Fti is the field value (0 for even, 1 for odd) in row drive period i

It is also assumed that the voltage difference between each of the pairs V₁, V₂; V₂, V₃; V₄, V₅; V₅, V₆ are all Vd.

The first part (Dti ⊕ Fti) ⊕ (Dti-1 ⊕ Fti-1) of the above formula calculates whether there will be a change of SEG signal relative to Vcom (transition detector, TD). As can be observed and can be easily deduced, there are two possibilities for this portion of the formula to produce a 1. One situation is when Fti is different from Fti-1 (i.e. field changed between even and odd) while Dti and Dti-1 are the same. The other condition is Dti and Dti-1 are different while Fti and Fti-1 are the same.

The second part of the formula, namely ((Dti ⊕ Fti) ?+1:−1), employs the notation where (expression 1? expression 2:expression 3) means that if expression 1, then expression 2, else expression 3. The second part of the formula ((Dti ⊕ Fti) ?+1:−1) calculates the direction of the voltage between Vseg and Vcom (direction detector DD), which depends on the field and on the data at time Ti and Ti-1.

The third part of the formula is the magnitude of the change, which will be a constant, depends on voltage difference between V₆, V₅, V₄ and V₁, V₂, V₃. To simplify the discussion, the difference between each pair of these voltages V₁, V₂; V₂, V₃; V₄, V₅; V₅, V₆ are assumed to be the same value Vd.

Although the action of COM electrode scanning is ignored in the above formula, however, due to the fact that 1) COM scanning represents an orthogonal operation relative to SEG electrode driving, and 2) in practical graphics type matrix LCD, the number of COM electrodes are generally significantly higher than 10, and only one of these COM electrodes will be going through the scanning operation at any time, the error produced by the simplification is negligible for the purpose of calculating SEG electrode current behavior.

Now, consider the circuit shown in FIG. 8, where switches S, SP, SN and SC are controlled by a pair of detectors (transition detector, TD and direction detector, DD) implemented for each SEG electrode using the formula given above. To simplify FIG. 8, the connections between DD and the switches S, SP, SN and SC have been omitted. TD has inputs Dti, Fti, Dti-1 and Fti-1 (not shown), and DD has inputs Dti and Fti (not shown). TD and DD may be implemented in a manner known to those in the art in view of the functional expressions for TD and DD in equation (1) above. A plurality of pairs of detectors TD, DD are employed, each of the pairs of detectors for detecting a corresponding column electrode, where each of the pairs of detectors is used to detect condition of the corresponding column electrode according to equation(1) above.

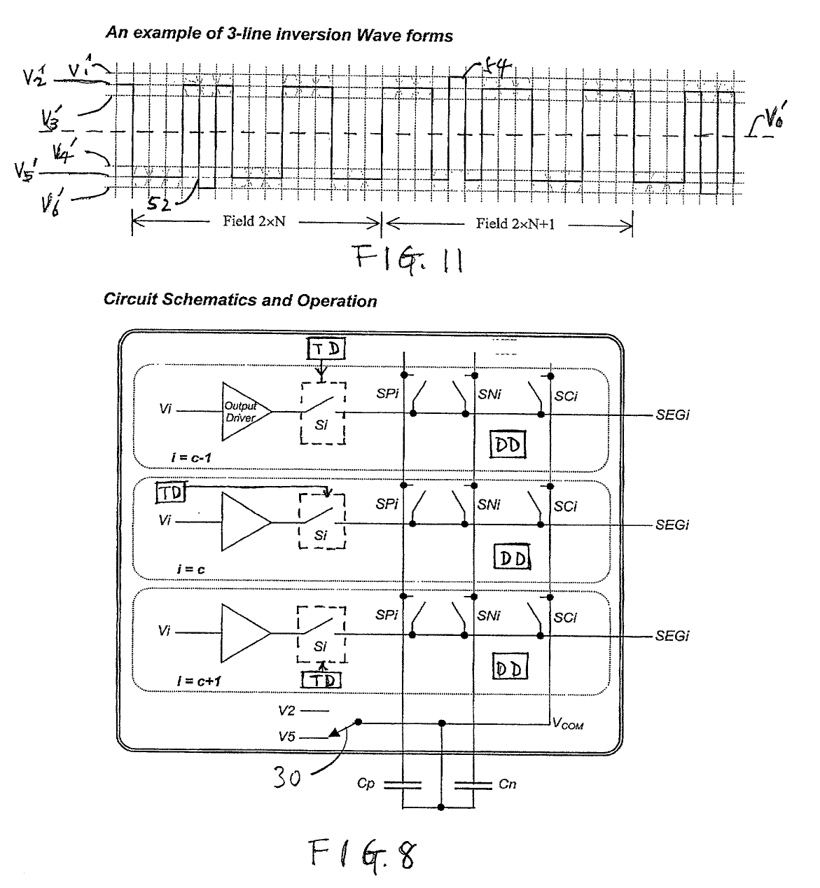

If TD output is 0 for certain SEG electrodes, then its corresponding switch S will remain in the CLOSE (X) position, and SP, SN and SC will remain in the OPEN positions. No switching action will happen to this SEG electrode during this time slot. If TD output is 1 for an SEG electrode, then depending on the output of its corresponding DD, switches SP/SN/SC will engage in a sequence of switching activities (FIG. 9) to produce a 4-phase charge conserving driving scheme (FIG. 10). Referring to the schematic in FIG. 8, and the switch action table in FIG. 9 and the expected waveform in FIG. 10, instead of connecting SEG electrode driving signal (Vi) directly from the output driver (symbolized as a triangle in the schematics) to SEG electrodes (SEGi), this invention introduced three additional phases of operation via the introduction of four switches: Si, SPi, SNi and SCi. FIG. 10 illustrates the voltage wave forms for SEG electrodes going through different transitions during certain COM row drive periods.

As demonstrated by the example shown in FIG. 10, the operation of the presently proposed driving scheme introduced three additional phases to the conventional one phase scheme:

t0˜t1: Storage phase: Charges from the SEG or column electrodes are stored into proper storage capacitor.

t1˜t2: Discharge phase: All SEG electrodes going through transition are connected to a common node Vcom. All of the row electrodes except for the one(s) being scanned or addressed are driven by the voltage at Vcom. Thus, the charges on the opposite plates of the capacitors formed by the row electrodes that are not scanned and by the column electrodes going through transtions will be discharged. This neutralizes substantially all of the capacitors affected by the column transitions except for those forming parts of the row electrode(s) being addressed.

t2˜t3: Transfer phase: The charges of the storage capacitors are transferred to proper SEG or column electrodes.

t3˜: Drive phase: Driving voltages are connected to the SEG electrodes (like conventional scheme). Only a portion of this phase is illustrated in FIG. 10.

The operation of each switch is as demonstrated in FIG. 9, in which the convention of FIG. 4 for indicating the “closing” and “opening” of switches at particular times is adopted. As shown by the example illustrated in FIG. 10, with the present scheme, the output drivers will only need to supply charges to the SEG electrodes for the transition from V_{Cn3} to −Vd for the negative going SEG electrodes and from V_{Cp3} to +Vd for the positive going SEG electrodes. Node Vcom is connected to voltage sources at V₂ and V₅ alternately through a switch 30, where the voltage at the node may be used to supply the non-scanning voltage for the row electrodes. By connecting the node Vcom to the capacitors Cp, Cn as shown in FIG. 8, the potentials applied to the column electrodes through Cp, Cn, and the potentials of Cp, Cn, are caused to float about the non-scanning potential (V₂, V₅ in FIG. 2) applied to the row or COM electrodes. The column electrodes thus undergo opposite voltage transitions in reference to the non-scanning potential (at V₂ or V₅ in the example above) which is between the two target potentials (V₁, V₃; V₄, V₆).

In typical STN LCD applications, such as cellular phone display, the displayed graphics data is changed relatively infrequently. For static graphics pattern assuming the capacitances of Cp and Cn are significantly larger than the SEG loading capacitance C_{LOAD} (for example, C_{P}=Cₙ=30 x SUM (C_{LOAD} of all SEG electrodes)), then, due to the exact symmetry of SEG signals between the even and odd fields, mathematical simulation indicates that the voltage across Cp and Cn will gradually approach (stabilized to) a symmetrical pair of values: ±Vd/2.

It is also possible to simplify the above described driving scheme by eliminating the discharge phase and the associated switches (SC) without significantly affecting the effectiveness of the scheme. In such simplified scheme, assuming C_{P} and Cₙ are both sufficiently larger than C_{LOAD}, then the stabilized value for C_{P} and Cₙ will be close to ±Vd/3, and V_{cp1} and V_{cp3} are substantially the same (equal to V_{cp}) and so are V_{cn1} and V_{cn3} (equal to V_{cn}). Therefore a theoretical maximum charge conversion ratio of 66% is achievable. Referring to FIG. 10, the SEG drivers only need to drive the SEG electrodes after t3, from V_{cn} to −V_{d} or from V_{cp} to +V_{d}, and therefore only need to provide charges for ⅓ of the 2x V_{d} total voltage transitions.

Alternatively, as in the case of row or COM electrodes illustrated in FIGS. 6, 7, it is also possible to eliminate the phases where the column electrodes are connected to capacitors, leaving only the discharge phase. In such instance, a theoretical maximum charge conversion ratio of 50% is achievable.

Generalized Scheme

The general charge saving scheme for passive LCD can be based on either one of the following phenomenon:

During one row drive period, there is one pair of transitions of opposite polarity (such as the case of COM electrode scanning, during the transition from one row electrode to the next row electrode as illustrated by ellipses 22, 24 of FIG. 2).

For mostly static images, due to the zero DC requirement for LCDs explained above, across two fields (one positive polarity voltage is applied to a pixel for one field, one negative polarity voltage is applied to the same pixel for the next field), the signal applied to the pixel(s) is largely of equal amplitude and of opposite signs. (Such as the case of SEG charge saving scheme.)

A generalized charge saving scheme can be described as:

Between the two target voltages of these transitions (e.g. V₅˜V₁, or V₂˜V₆, for the COM transitions and V₆˜V₄ or V₃˜V₁ for the SEG transitions) there can be N storage capacitors (preferably the capacitance value of each of the capacitors should be>>the load capacitance). For ease of discussion, the N capacitors are CN˜C1, and they are arranged in sequence such that the voltage of CN will, for example, have stabilized voltage closest to V₆ and the voltage of C1 will be stabilized close to V₂, for the V₂˜V₆ COM transition.

The COM electrode transition from V₆ to V₂ will be achieved by first connecting the electrode to CN and then sequentially to CN-1, . . . , C1. And for V₂˜V₆ transition, the electrode will be connected sequentially to C1, . . . , CN. The same scheme may be applied for SEG or column electrode transitions between V₁˜V₃, and V₄˜V₆. It should be noted that, for the capacitors for storing and re-using charges for the SEG electrodes, the reference potential is floating (for example, referenced to the non-scanning potential of the COM electrodes) and not to ground.

Assuming CN˜C1 capacitance is>>total loading capacitance, then after a finite stabilizing period of time, these N charge storage capacitors (C1˜CN) for the COM electrodes will stabilize to a situation where V₆>V_{CN}>V_{CN}-V_{CN-1}>. . . >V_{C1}-V₂. By connecting the capacitors to Vcom (at V₂, V₅ in FIG. 2), the same reasoning would apply to the SEG electrodes where the N charge storage capacitors (C1˜CN) for the SEG electrodes will stabilize to a situation where V_{d}-V_{CN}≅V_{CN}-V_{CN-1}≅. . . ≅V_{C1}-(-V_{d}). After the system is stabilized, the charge saving ratio will equal to 1/N+1; that is, if N capacitors are used, only the last step of amplitude 1/(N+1) of total voltage swing transition will require driving current from (COM/row or SEG/column) driver. The spacings or steps between the potentials of the capacitors are practically equal for small values of N, such as where N is less than 4.

Circuit Schematic

In the generalized scheme, the number of switches required is proportional to the number of stages for the charge saving. In general, an N stage charge saving scheme requires N-1 capacitors and N switches. However, this is only a rule of thumb, and can vary based on design considerations. Examples are given above for both the COM and SEG charge saving schemes.

Difference between COM(row) and SEG (column) scheme

The observed difference between the two disclosed schemes is mainly in the interpretation of the voltage swing. In the case of COM (row) charge saving, the reference is to a stable voltage (e.g. GND), while in the case of SEG (column) charge saving, the reference is to a moving voltage (e.g. V₂ or V₅). If the perspective taken is one seen from the “majority of the pixels”, then there is no difference between these two schemes. In the case of SEG electrodes, the “majority” of the corresponding COM electrodes oscillate between two potentials (e.g. V₂ and V₅). When seen from these “majority” of the corresponding COM electrodes, the voltage swings of the SEG electrodes again are in reference to a stable voltage.

Therefore, one important observation upon which this invention is based is that the charge saving capacitors need to connect to a “neutral” reference point relative to transition nodes. In the case of the COM electrodes this “neutral” reference can be the ground voltage, while for the SEG electrodes this “neutral” reference should be the “non-scanning” voltage for COM electrode, which is V₂ or V₅ in the examples given above, depending on the current polarity of display.

Special Situation

When the pair of opposite transitions happens at the same time (e.g. the COM/row scanning operation in ellipses 22, 24 shown in FIG. 2) and when the desired charge saving ratio is 1/N where N is an even number, then the required number of capacitors is N-2, rather than N-1. This is accomplished by replacing one of the steps by connecting the two opposite going electrodes together instead of connecting to a charge saving capacitor, which would otherwise be required and have a stabilized voltage very close to (V₆+V₁)/2. A specific N=4 case has been demonstrated for the COM charge saving scheme above, as well as the special case of N=2 which requires no capacitor at all.

Applicable to both Field Inversion and Row Inversion Driving Scheme

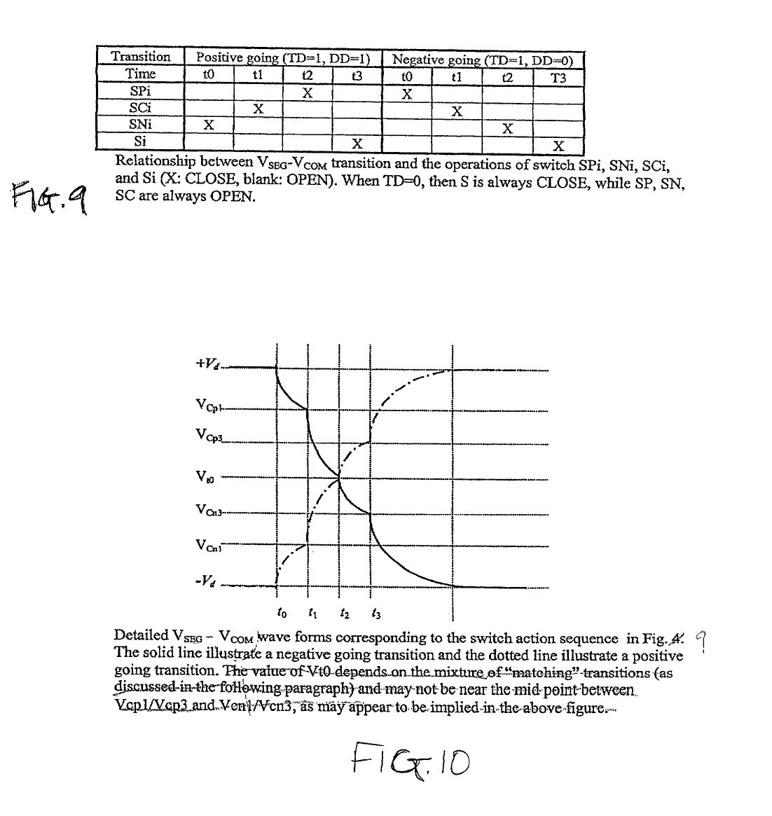

The above generalized charge saving scheme is equally applicable to LCDs operated with the Field Inversion LCD Driving Scheme and with the Row Inversion LCD Driving Scheme. FIG. 11 is a graphical illustration of an electrical potential signal which may be applied to row electrodes of FIG. 1 useful for illustrating a row inversion scheme. The voltage waveform illustrated in FIG. 11 is suitable for a row inversion scheme where the voltage or potential of the addressing signal applied to the row or COM electrodes are inverted between adjacent sets of three adjacent row or COM electrodes each. In reference to FIG. 11, each field (2xN, 2xN+1) is covered by 15 row electrodes broken into five sets of three row electrodes each, arranged in an array. The waveform shown in FIG. 11 is the one suitable for addressing or scanning the middle one of the second set of three adjacent row electrodes in the array. For field 2xN, the scanning pulse 52 for addressing this electrode is negative going whereas for field 2xN+1, the scanning pulse 54 is positive going. Thus, for addressing or scanning the first row electrode in the second set to be addressed, the scanning pulse would occur one row drive period before pulses 52, 54 shown in FIG. 11, and that for addressing or scanning the last row electrode in the second set, the addressing or scanning pulse would occur after pulses 52, 54 in FIG. 11. Aside from such differences, the waveform of the voltage signals applied to the two remaining (first and last) row electrodes in the second set are similar to that shown in FIG. 11 for the middle row electrode.

In FIG. 11, the voltage signal illustrated has a reference potential V₀′. For the first and third sets of three adjacent row electrodes in the array of five sets of row electrodes, the waveform of the potentials applied to these sets will be inverted from that shown in FIG. 11, where the voltage waveform applied to the second row electrode in the first and third sets would resemble that shown in FIG. 11 but inverted from it about the line V₀′. Thus, for adjacent row electrodes in two different sets in the array, different non-scanning potentials are applied to them. As will be evident to those in the art, all of the features described above illustrated using the field inversion scheme are applicable to LCDs using row inversion schemes, including the one illustrated in FIG. 11.

Equation (1) has been described above in reference to a field inversion scheme, where all of the COM electrodes are driven with signals of the same polarity, but they are driven with signals of opposite polarities between even and odd fields. In the row inversion scheme, different row electrodes undergoing opposite transtions are driven with signals of opposite polarities. Therefore, an analogy may be drawn between the two schemes, and equation (1) is applicable to row inversion schemes by replacing the field indicator Fti, Fti-1 by polarity indicator Pti, Pti-1, so that the modified equation (1) may be applied across different row electrodes undergoing opposite transtions in the row inversion scheme. In fact, a general formulation is arrived at by such modification, since field inversion also calls for the signals applied across even and odd fields to be of opposite polarities.

Portions of control circuits for driving the row and column electrodes of FIG. 1 are illustrated in FIGS. 3 and 8. The entire control circuit for driving the row or column electrodes may be implemented in the form of an integrated circuit. While the capacitors Cp, Cn may be implemented as a part of the integrated circuit for the control circuit, it may be desirable to implement the capacitors in the form of discrete components, especially where capacitors of large value capacitances are used.

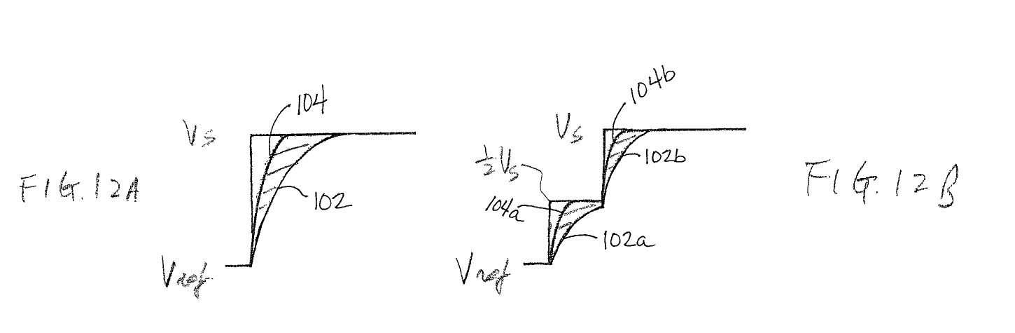

As noted above, the difference in capacitance values of pixels that are turned ON and those that are turned OFF will cause the RC delays to be different from row to row, and create a shadow between two rows of pixels such as in text display applications. This effect is illustrated in FIG. 12A. As shown in FIG. 12A, 102 represents the voltage difference between a selected row electrode and a selected column electrode for a pixel in the ON state and 104 represents the voltage across a selected row and a selected column electrode for a pixel in the OFF state. In other words, the voltage across OFF pixels reach the desired value faster then that for pixels in the ON state, which can create shadows or other distortions. This is undesirable.

In reference to FIG. 2 for row electrode i+1 during field 2xN, ellipse 22 encircles the falling edge of a scanning voltage waveform for addressing the row electrode i+1. Thus, the scanning voltage is at value V₆ and the non-scanning voltage is V₂. At the end of the scanning pulse, the voltage applied to the row electrode i+1 rises from V₆ to V₂. During the subsequent field 2xN+1 and in reference to ellipse 24, the scanning voltage is V₁ and the non-scanning voltage is V₅. Therefore, in either case, and ignoring the polarities of the signals, the scanning voltage V₆, V₁ may be represented by Vₛ and the non-scanning voltage V₂, V₅, which is a reference voltage, may be represented by V_{ref}. This is illustrated in FIG. 12A.

Thus, after the scanning voltage is applied to the row electrode, because of the difference in RC delay, the pixel to be turned off and addressed by the scanning voltage Vₛ will reach the value Vₛ faster then the pixel which is turned on by another different row electrode. This is illustrated by graphs 102 and 104. Thus in FIG. 12A, graph 102 represents the voltage of the row electrode addressing pixels which are turned on whereas graph 104 represents the voltage of the row electrode addressing pixels that are turned off. Where a large number of pixels on one of the rows are in the ON state, while other rows have almost no ON row pixels, these other rows will be turned off before the single row having a large number of ON pixels are turned on, thereby causing shadows or other distortions.

As noted above, the resistance values of the ITO traces connecting the different row electrodes to the power supply may be different, due to the non-uniformity or different lengths of the traces, thereby also introducing another source of difference in RC delay between different row electrodes and pixels.

This invention is based on the observation that the above-described shadows and other undesirable effects can be reduced by causing the voltages applied to the row electrodes to step through at least two increments or incremental steps as illustrated in FIG. 12B. Thus, instead of applying the full scanning voltage Vₛ to the row electrode, first a scanning voltage substantially equal to one-half of the full scanning voltage, or ½.Vₛ, is first applied to the row electrode for a time period and then the full scanning voltage Vₛ is then applied. Preferably the time period for which the ½.Vₛ scanning voltage is applied is long enough for the slow switching row electrodes to catch up with the fast switching ones on account of their different RC delays before the full scanning voltage .Vₛ is applied. In other words, the multiple-step driving waveform of FIG. 12B creates one or more equalizing points, where the fast switching row electrodes (those with low RC delays), will reach the intermediate voltage level(s) first and wait for slower switching row electrodes, before the next higher voltage of the multiple-step waveform is applied.

Obviously, the full scanning voltage Vₛ may be divided into smaller increments than that shown in FIG. 12B and a set of two or three or more different scanning voltages may be caused to be applied sequentially to the row electrodes where each voltage is applied for an adequate time to allow the slower switching row electrodes to catch up with the fast switching ones. Thus in FIG. 12B, when the scanning voltage of ½.Vₛ is applied, the fast switching row electrodes will reach such scanning voltage along the curve 104a while the slower switching row electrodes will reach such value along the curve 102a. Then when the full scanning voltage Vₛ is applied, the fast switching row electrodes will reach such value along curve 104b and the slow ones along curve 102b.

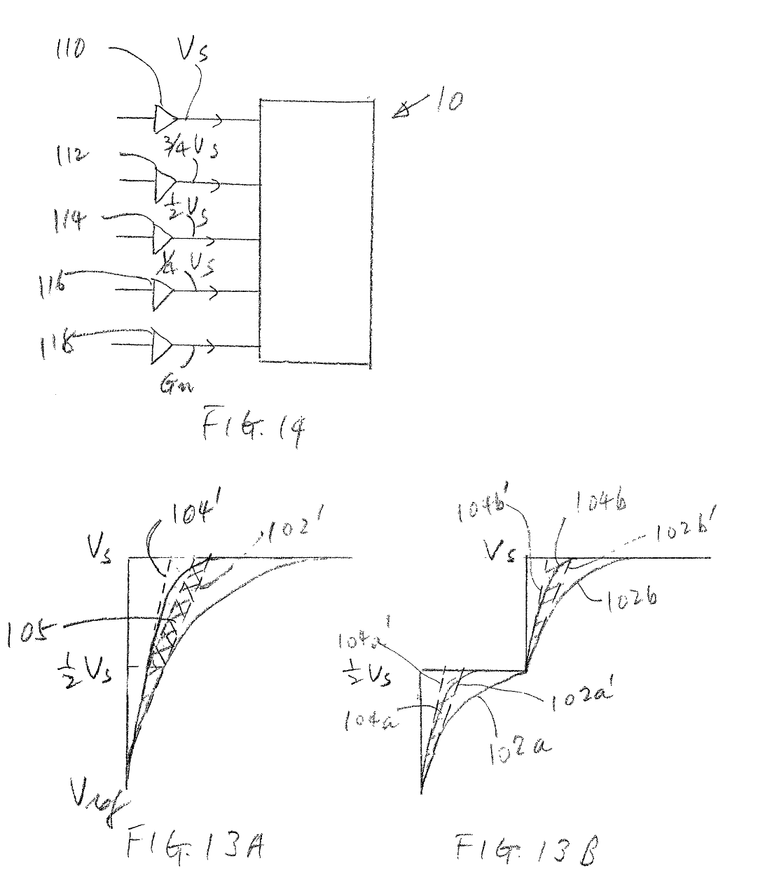

The difference in delay between the scheme of FIG. 12B and that of FIG. 12A is illustrated by the shaded areas between the curves 102a, 104a, 102b and 104b on the one hand and curve 102 and 104 on the other. Since the optical properties of liquid crystals responds to root means square of the scanning voltage, the shaded area between curve 102a and 104a can be substantially ignored since this is much less significant compared to the shaded area at a higher voltage such as that between graphs 102b and 104b. Even a visual comparison between the shaded area between curve 102b, 104b will show that it is much smaller then the upper portion of the shaded area between curve 102 and 104 in FIG. 12A. The difference is illustrated more clearly in reference to FIG. 13A and 13B.

FIG. 13A is the same as FIG. 12A except that curve 102 is now approximated by a straight line 102′ and curve 104 is approximated by curve 104′. The same approximations are employed in FIG. 13B in reference to FIG. 12B. Comparing FIGS. 13A and 13B, the double shaded area 105 marks the difference between the shaded areas bounded by lines 102′, 104′ above the line ½.Vs in FIG. 13A and the area bounded by lines 102b′, 104b′ above the line ½.Vₛ.

Where the scanning voltage Vₛ is divided into four substantially equal increments, a power supply may be employed to supply the scanning voltage Vₛ and voltages that are substantially equal to quarter fractions of the scanning voltage Vₛ to the LCD display 10 of FIG. 1. As illustrated in FIG. 14, for example, independent power supplies (not shown) may be used to supply through drivers 110, 112, 114, 116, 118 the scanning voltages V₅, ¾Vₛ, ½Vₛ, ⅓Vₛ and ground to the row electrodes of LCD display 10, where the four different voltages applied by drivers 110-116 are applied sequentially, starting with the lowest scanning voltage. Obviously Vₛ may be divided into fewer or more than four increments, where the increments can be equal or unequal; such variations are within the scope of the invention.

Instead of having to supply all of the voltages for the increments, some of these may be accomplished using switches and capacitors, such as in the embodiments described above. Thus, one or more capacitors such as those shown in FIG. 3 may be employed to deliver electrical charges to or absorb electrical charges from the row electrodes, as illustrated during the time periods t0 to t1 and t2 to t3 in FIG. 5, to achieve the stepping through of the voltage increments of the row electrodes involved. Alternatively, these increments can be achieved by connecting together row electrodes that are undergoing opposite voltage transitions, such as during the time period t1 to t2 in FIG. 5. These operations using switches are illustrated in FIGS. 3, 4 and 5 and described in detail in the description above in reference thereto. Such and other embodiments are within the scope of the invention.

The above concept of causing the electrical potentials applied to the row electrodes to step through increments is applicable to active matrix type as well as passive LCD displays, and to single and multiple line scanning LCDs.

While the invention has been described above by reference to various embodiments, it will be understood that changes and modifications may be made without departing from the scope of the invention, which is to be defined only by the appended claims and their equivalents. All references referred to herein are incorporated in their entirety by reference.

What is claimed is:

1. A method for driving a liquid crystal display, said display comprising an array of elongated row and an array of elongated column electrodes arranged transverse to the row electrodes, wherein overlapping areas of the two arrays of electrodes define pixels of the display when viewed in a viewing direction, said method comprising:
applying electrical potentials to the two arrays of electrodes to cause the display to display desired images, wherein two of the row electrodes substantially simultaneously undergo opposite voltage transitions in reference to a reference potential; and
electrically connecting said two row electrodes undergoing opposite voltage transitions to reduce power consumption.

2. The method of claim 1, wherein said applying applies electrical potentials to the array of row electrodes so that pairs of row electrodes are caused to undergo opposite voltage transitions in reference to the reference potential, and wherein said connecting connects each of said pairs to reduce power consumption.

3. A method for driving a liquid crystal display, said display comprising an array of elongated row and an array of elongated column electrodes arranged transverse to the row electrodes, wherein overlapping areas of the two arrays of electrodes define pixels of the display when viewed in a viewing direction, said method comprising:
applying electrical potentials to the two arrays of electrodes to cause the display to display desired images, wherein said applying applies scanning electrical potentials to at least one of the row electrodes, and non-scanning electrical potentials to the remaining row electrodes, said non-scanning electrical potentials being applied by means of voltage at a node; and
electrically connecting at least some of said column electrodes to the node to reduce power consumption.

4. The method of claim 3, wherein the row electrodes and the column electrodes form opposing plates of a two dimensional array of capacitors, and wherein said applying also applies data potentials to the column electrodes for display of images at the pixels, thereby applying said potentials to the opposing plates of the capacitors in the array of capacitors.

5. The method of claim 4, wherein the electrically connecting causes charges on the opposite plates of the capacitors connected to the node to be discharged.

6. The method of claim 3, wherein said at least some of the column electrodes undergo opposite voltage transitions in reference to the non-scanning potential.

7. The method of claim 6, wherein said at least some of the column electrodes undergo opposite voltage transitions between two potentials, and wherein the non-scanning potential is between the two potentials.

8. The method of claim 6, wherein the non-scanning potential varies with time during the display of images.

9. The method of claim 8, wherein the non-scanning potential is alternately switched between two different values in successive display cycles.

10. The method of claim 8, wherein the non-scanning potential is alternately switched between two different values, and wherein non-scanning potentials applied to adjacent row electrodes are different.

11. The method of claim 3, wherein the electrical potentials are applied to achieve a row or field inversion scheme.

12. The method of claim 3, further comprising detecting a condition where one of the column electrodes would undergo voltage transitions prior to the connecting.

13. The method of claim 12, said method being performed using a plurality of detectors, each of the detectors for detecting a corresponding column electrode, said detecting including using each of the detectors to detect said condition of the corresponding column electrode.

14. The method of claim 12, wherein said connecting connects only the column electrode(s) that would undergo voltage transition(s) to the node.

15. A method for driving a liquid crystal display, said display comprising an array of elongated row electrodes and an array of elongated column electrodes arranged transverse to the row electrodes, wherein the row electrodes and the column electrodes form opposing plates of a two dimensional array of capacitors, and wherein overlapping areas of the two arrays of electrodes define pixels of the display when viewed in a viewing direction, said method comprising:
applying electrical potentials to the two arrays of electrodes, wherein said applying applies scanning and non-scanning potentials to the row electrodes and data potentials to the column electrodes for display of images at the pixels, thereby applying said potentials to the opposing plates of the capacitors in the array of capacitors, and wherein at least one of the electrodes in one of the two arrays undergoes a voltage transition between a first and a second electrical potential, the first electrical potential being higher than the second electrical potential;
wherein said applying includes:
(a) connecting the at least one electrode sequentially to at least a first capacitor, the first capacitor being at an electrical potential between the two potentials; and
(b) connecting the at least one electrode to at least one driver after connection to the at least first capacitor.

16. The method of claim 15, wherein said connecting in (a) connects the at least one electrode sequentially to at least a first and a second capacitor, wherein the first capacitor is at a higher electrical potential than the second capacitor, so that when the at least one electrode transitions from the first potential to the second potential, it is connected first to the first capacitor and then to the second capacitor, and when the at least one electrode transitions from the second potential to the first potential, it is connected first to the second capacitor and then to the first capacitor.

17. The method of claim 16, wherein the column electrodes undergo opposite voltage transitions in reference to the non-scanning potential, and wherein the applying applies the non-scanning potential to the at least first and second capacitors.

18. The method of claim 16, wherein the first potential is higher than a reference potential of the capacitors and the second potential is lower than the reference potential, and wherein said reference potential is substantially the non-scanning potential.

19. The method of claim 18, wherein said non-scanning potential is switched between two different potentials, so that said reference potential is also switched between said two different potentials, and so that the potentials of the capacitors float with the non-scanning potential.

20. The method of claim 15, further comprising detecting a condition where at least one column electrode would undergo voltage transitions prior to connecting such column electrodes in (a).

21. The method of claim 20, said method being performed using a plurality of detectors, each of the detectors for detecting a corresponding column electrode, said detecting including using each of the detectors to detect said condition of the corresponding column electrode.

22. The method of claim 20, wherein said connecting in (a) connects to at least the first capacitor only the column electrode(s) that would undergo voltage transition(s).

23. The method of claim 15, wherein at least one of the electrodes in said one of the two arrays undergoes voltage transitions between the first and second electrical potentials, and wherein said connecting in (a) connects the at least one electrode to up to N capacitors at different electrical potentials, N being an integer greater than 1, so that when the at least one electrode undergoes transition from a higher electrical potential to a lower one is connected sequentially to two or more of the capacitors in descending order of their electrical potentials, and when the at least one electrode undergoes transition from a lower electrical potential to a higher one is connected sequentially to two or more of the capacitors in ascending order of their electrical potentials.

24. The method of claim 23, wherein said applying causes at least one pair of row electrodes to substantially simultaneously undergo opposite voltage transitions in reference to a reference potential, and causes such pair to be electrically connected to reduce power consumption.

25. The method of claim 15, wherein said applying causes column electrodes undergoing transitions to be connected to a node to reduce power consumption.

26. The method of claim 25, wherein the non-scanning potential being applied by means of a voltage at the node.

27. The method of claim 15, wherein the column electrodes undergo opposite voltage transitions in reference to the non-scanning potential.

28. The method of claim 27, wherein the column electrodes undergo opposite voltage transitions between the two potentials, and wherein the non-scanning potential is between the two potentials.

29. The method of claim 27, wherein the applying applies the non-scanning potential to the first capacitor.

30. The method of claim 27, wherein the non-scanning potential varies with time during the display of images.

31. The method of claim 30, wherein the non-scanning potential is alternately switched between two different values in successive display cycles.

32. The method of claim 30, wherein the non-scanning potential is alternately switched between two different values, and wherein non-scanning potentials applied to adjacent row electrodes are different.

33. The method of claim 15, wherein the electrical potentials are applied to achieve a row or field inversion scheme.

34. A method for driving a liquid crystal display, said display comprising an array of elongated row electrodes and an array of elongated column electrodes arranged transverse to the row electrodes, wherein overlapping areas of the two arrays of electrodes define pixels of the display when viewed in a viewing direction, said method comprising:
supplying electrical potentials to the two arrays of electrodes to cause the display to display desired images, wherein said supplying includes:
applying electrical potentials to the array of column electrodes so that at least one of the column electrodes undergoes voltage transitions;
connecting the at least one column electrode to a node to reduce power consumption; and
applying scanning and non-scanning electrical potentials to the row electrodes, the non-scanning potential being applied by means of a voltage at the node.

35. The method of claim 34, further comprising switching said voltage at the node between two different potentials, so that said non-scanning potential is also switched between said two different potentials.

36. A system for driving a liquid crystal display, said display comprising an array of elongated row and an array of elongated column electrodes arranged transverse to the row electrodes, wherein overlapping areas of the two arrays of electrodes define pixels of the display when viewed in a viewing direction, said system comprising:
a circuit applying electrical potentials to the two arrays of electrodes to cause the display to display desired images, wherein two of the row electrodes substantially simultaneously undergo opposite voltage transitions in reference to a reference potential; and
a switch electrically connecting said two row electrodes undergoing opposite voltage transitions to reduce power consumption.

37. A system for driving a liquid crystal display, said display comprising an array of elongated row and an array of elongated column electrodes arranged transverse to the row electrodes, wherein overlapping areas of the two arrays of electrodes define pixels of the display when viewed in a viewing direction, said system comprising:
a circuit applying electrical potentials to the two arrays of electrodes to cause the display to display desired images, wherein said applying applies scanning electrical potentials to at least one of the row electrodes, and non-scanning electrical potentials to the remaining row electrodes, said non-scanning electrical potentials being applied by means of voltage at a node; and
a switch electrically connecting said column electrodes to the node to reduce power consumption.

38. A system for driving a liquid crystal display, said display comprising an array of elongated row electrodes and an array of elongated column electrodes arranged transverse to the row electrodes, wherein the row electrodes and the column electrodes form opposing plates of a two dimensional array of capacitors, and wherein overlapping areas of the two arrays of electrodes define pixels of the display when viewed in a viewing direction, said system comprising:
a circuit applying electrical potentials to the two arrays of electrodes, wherein said applying applies scanning and non-scanning potentials to the row electrodes and data potentials to the column electrodes for display of images at the pixels, thereby applying said potentials to the opposing plates of the capacitors in the array of capacitors, and wherein at least one of the electrodes in one of the two arrays undergoes a voltage transition between a first and a second electrical potential, the first electrical potential being higher than the second electrical potential;
wherein said circuit includes:
(a) a switch connecting the at least one electrode sequentially to at least a first capacitor, the first capacitor being at an electrical potential between the two potentials; and
(b) a switch connecting the at least one electrode to at least one driver after connection to the at least first capacitor.

39. The system of claim 38, wherein at least a portion of said circuit is an integrated circuit.

40. The system of claim 39, wherein the first capacitor forms a portion of the integrated circuit.

41. The system of claim 39, wherein the first capacitor is a discrete device separate from the integrated circuit.

42. A system for driving a liquid crystal display, said display comprising an array of elongated row electrodes and an array of elongated column electrodes arranged transverse to the row electrodes, wherein overlapping areas of the two arrays of electrodes define pixels of the display when viewed in a viewing direction, said system comprising:
a circuit supplying electrical potentials to the two arrays of electrodes to cause the display to display desired images, wherein said circuit applies electrical potentials to the array of column electrodes so that at least one of the column electrodes undergoes voltage transitions;
a voltage source connected to a node; and
a switch connecting the at least one column electrode to the node to reduce power consumption;
wherein the circuit applies scanning and non-scanning electrical potentials to the row electrodes, and wherein the non-scanning potential is applied by means of the voltage at the node.

43. A method for driving a liquid crystal display, said display comprising an array of elongated row, an array of elongated column electrodes arranged transverse to the row electrodes and a layer of liquid crystal material between the two arrays, comprising:
causing different electrical potentials to be applied sequentially to at least one of the two arrays of electrodes to cause a voltage difference between selected electrodes of the two arrays to reach a value that causes one or more portions of the liquid crystal layer to change its optical properties and thereby display desired images;
wherein the electrical potentials applied cause the value of the voltage difference to be reached in two or more increments.

44. The method of claim 43, wherein the causing applies first electrical potentials to the two arrays for a first time period to cause the voltage difference to step closer to a fraction of said value, and subsequently applies at least second electrical potentials to the two arrays to cause the voltage difference to increase to said value in at least one additional increment.

45. The method of claim 43, wherein the causing applies the first and at least the second different electrical potentials sequentially to the array of row electrodes.

46. The method of claim 43, wherein the causing causes two row electrodes that are undergoing opposite voltage transitions to be connected together.

47. The method of claim 43, wherein the causing causes at least one row electrode to be connected to a passive electronic device.

48. The method of claim 43, wherein the causing causes at least one row electrode to be connected to a capacitor.

49. An apparatus for driving a liquid crystal display, said display comprising an array of elongated row, an array of elongated column electrodes arranged transverse to the row electrodes and a layer of liquid crystal material between the two arrays, said apparatus comprising:
a circuit causing different electrical potentials to be applied sequentially to at least one of the two arrays of electrodes to cause a voltage difference between selected electrodes of the two arrays to reach a value that causes one or more portions of the liquid crystal layer to change its optical properties and thereby display desired images;
wherein the electrical potentials applied cause the value of the voltage difference to be reached in two or more increments.

50. The apparatus of claim 49, said apparatus comprising more than two power sources supplying said different electrical potentials to the electrodes.

51. The apparatus of claim 49, wherein said circuit includes switches, two power supplies and one or more capacitors connectable to the supplies by the switches to supply said different electrical potentials to the electrodes.

52. The apparatus of claim 49, wherein the circuit connects together two row electrodes that are undergoing opposite voltage transitions.

53. The apparatus of claim 49, wherein the circuit connects at least one row electrode to a passive electronic device.

54. The apparatus of claim 49, wherein the circuit connects at least one row electrode to a capacitor.

55. The apparatus of claim 49, said apparatus being an active matrix device.

56. The apparatus of claim 49, wherein said circuit causes electrical potentials to be applied so that more than one line of the display is scanned during at least one scanning cycle.
